(19) United States
(12) Patent Application Publication
(10) Pub. No.: US 2026/0210455 A1
(43) Pub. Date: Jul. 23, 2026

(54) REFRIGERANT VALVE

(71) Applicant: Volkswagen Aktiengesellschaft, Wolfsburg (DE)

(72) Inventor: Tonio-Erik SCHULTZE, Wolfsburg (DE)

(73) Assignee: Volkswagen Aktiengesellschaft, Wolfsburg (DE)

(21) Appl. No.: 19/455,783

(22) Filed: Jan. 21, 2026

(30) Foreign Application Priority Data
Jan. 22, 2025 (DE) 10 2025 102 239.9

(51) Int. Cl. F16K 31/04; F16K 17/02

(52) U.S. Cl. CPC F16K 31/046; F16K 17/02

(57) ABSTRACT

In order to provide a refrigerant valve including a valve housing that has simpler component geometries and a more compact design, a refrigerant valve comprising a valve housing and a drive is proposed. The valve housing has a refrigerant channel with at least one inlet opening and an outlet opening for a refrigerant. A control element is situated in the refrigerant channel, and a control gap is formed between the control element and an inner wall of the refrigerant channel. According to the invention, for controlling the control gap, a diameter of the control element is changeable via the drive.

This nonprovisional application claims priority under 35 U.S.C. § 119(a) to German Patent Application No. 10 2025 102 239.9, which was filed in Germany on January 22, 2025, and which is herein incorporated by reference.

### BACKGROUND OF THE INVENTION

### Field of the Invention

The present invention relates to a refrigerant valve comprising a valve housing and a drive, the valve housing having a refrigerant channel with at least one inlet opening and an outlet opening for a refrigerant, a control element being situated in the refrigerant channel, and a control gap being formed between the control element and an inner wall of the refrigerant channel.

### Description of the Background Art

Refrigerant valves are used in large numbers In refrigerant circuits, in particular in refrigerant circuits of present battery-powered electric motor vehicles. Refrigerant valves known from the prior art include a valve housing with a refrigerant channel situated therein. A refrigerant may be supplied to the refrigerant channel through at least one inlet opening, and discharged therefrom through an outlet opening. A valve needle which can be moved axially in the refrigerant channel by a drive, for example an electric motor, is provided in the refrigerant channel. To control the flow rate of a refrigerant through the refrigerant channel, the valve needle has a tapering contour; i.e., its diameter decreases toward the outlet opening. In the area of the outlet opening the valve housing also has an undercut in the refrigerant channel. The valve housing together with the undercut forms a sealing seat for the valve needle at the outlet opening. When the valve needle is retracted into the sealing seat, the refrigerant valve closes. The geometries of the valve housing and of the valve needle to be machined are very complex and therefore cost-intensive. In addition, due to the principle of the moving valve needle, a rod seal or piston seal is also necessary for refrigerants with high pressure differences (CO₂, for example).

DE 102006029267 A1 discloses a control valve for the refrigerant R744 for controlling a high pressure difference between an inlet and outlet of the refrigerant in the valve, using an actuating device that actuates an actuating rod in a guide bore situated in the valve and that extends in the axial direction, the actuating rod at its end facing the inlet and outlet having a sealing element, wherein by a lifting movement of the actuating rod, the sealing element opens or closes its sealing seat, and thus, the inlet or outlet.

A valve assembly for an injection valve, and an injection valve for a combustion chamber of an internal combustion engine, are known from EP 2003331 A1, comprising a valve body including a central longitudinal axis, the valve body having a cavity that forms an inner wall, the cavity comprising a fluid outlet portion with a seat area that is part of the inner wall, and a valve needle that is axially movable in the cavity, the valve needle preventing a fluid flow through the fluid outlet portion in a closed position and releasing the fluid flow in a fluid flow direction through the fluid outlet portion in further positions.

### SUMMARY OF THE INVENTION

It is therefore the object of the present invention to provide a refrigerant valve including a valve housing that has simpler component geometries and a more compact design.

To achieve the object, in an example of the invention, a refrigerant valve comprising a valve housing and a drive is provided, the valve housing having a refrigerant channel with at least one inlet opening and an outlet opening for a refrigerant, a control element being situated in the refrigerant channel, and a control gap being formed between the control element and an inner wall of the refrigerant channel, it being provided that for controlling the control gap, a diameter of the control element is changeable by means of the drive.

Control of the control gap can be understood to mean an increase or decrease in the size of the control gap, so that a flow rate of a refrigerant through the refrigerant channel, in particular from the at least one inlet opening to the outlet opening, may be controlled or regulated.

The refrigerant channel can extend along an axial direction. The diameter of the control element more preferably lies in a plane perpendicular to the axial direction.

It may advantageously be provided that the control gap has a ring-shaped design between the inner wall of the refrigerant channel and the control element.

For controlling the control gap, a diameter of the control element can be changeable by means of the drive. This may in particular mean that when the diameter increases, the preferably ring-shaped control gap becomes smaller or narrower. For a maximum increase in the diameter of the control element, the control gap disappears or is closed. When the diameter of the control element is decreased or reduced, the ring-shaped control gap is enlarged, so that the flow rate through the refrigerant valve is increased from the at least one inlet opening to the outlet opening.

Compared to the prior art, for the refrigerant valve according to the invention in particular no valve needle is provided. The component geometries, in particular the geometry of the refrigerant channel, may thus have a simplified design. Undercuts are not required in the refrigerant channel.

It is preferably provided that the control element can have an axial length, the axial length being changeable by means of the drive, and a decrease in the axial length resulting in an increase in the diameter of the control element.

The axial length of the control element can refer to the extension of the control element in the axial direction of the refrigerant channel. If the axial length of the control element is reduced by means of the drive, an increase in the diameter of the control element is brought about at the same time. Conversely, an increase in the axial length results in a decrease in the diameter of the control element, and thus results in a higher flow rate of refrigerant through the refrigerant channel.

It is preferably provided that the refrigerant channel can be cylindrical and/or that the refrigerant channel can be a borehole.

The refrigerant channel may thus have a particularly simple design, and in particular does not require undercuts or similar complex geometries. In particular, the refrigerant channel may have a constant diameter over its entire axial length.

It is further advantageously provided that the control element can have a first section and a second section, a deformation section being situated between the first section and the second section, and the second section being movable relative to the first section by means of the drive.

The first section may be a region of the control element or an individual component of the control element. Likewise, the second section may be a region or an individual component of the control element. A deformation section is situated between the first section and the second section. If the second section is moved relative to the first section by means of the drive, in particular a distance between the first section and the second section is increased or decreased, so that the axial length of the control element is increased or decreased, and correspondingly the diameter of the control element is decreased or increased. The decrease of increase in the diameter of the control element is provided by deformation of the deformation section. The first section and the second section are situated above or below one another with respect to the axial direction of the refrigerant channel and/or with respect to the axial length of the control element. The first section may in particular be situated closer to the at least one inlet opening, while the second section of the control element is situated closer to the outlet opening of the refrigerant channel.

The drive can be an electric motor with a rotor shaft, and that the control element is a motion thread, the motion thread converting a rotational movement of the rotor shaft into an axial movement of the second section.

By means of the motion thread, a rotational movement of the rotor shaft can be converted into an axial movement of the second section, so that the distance between the first section and the second section changes, and the diameter, in particular of the deformation section, may thus be decreased or increased.

It is also possible for the drive to be a pneumatic drive. In this case, the control element may be a balloon that can be acted on with pressure by the pneumatic drive. Increasing the pressure within the balloon increases its diameter, thus reducing the size of the control gap.

It may particularly advantageously be provided that the control element, in particular the second section, includes a rivet, in particular a threaded rivet, the rivet being axially moved by the motion thread, and the rivet preferably being rotatably fixedly connected to the control element.

In particular, the thread of the threaded rivet may be situated in the motion thread. Due to the interaction of the thread of the threaded rivet and an internal thread of the motion thread, a rotational movement of the rotor shaft may be converted into an axial movement of the second section, in particular of the threaded rivet.

It is further advantageously provided that the control element can be an expansion element.

The deformation section of the expansion element can be preferably designed approximately in the form of bellows.

It may further advantageously be provided that the control element, in particular the first section, can be fixedly connected to the valve housing, wherein the control element, in particular the first section, preferably includes a guide tube, and the guide tube is fixedly connected to the valve housing, and the rotor shaft is situated in the guide tube.

The fixed connection of the first section to the valve housing can have a rotatably fixed, pressure-tight design. In particular, the first section of the control element is not axially displaceable or movable within the refrigerant channel. The first section may include a guide tube that is connected to the valve housing in a rotatably fixed, pressure-tight, and axially nondisplaceable manner. In this case the rotor shaft is preferably led through the guide tube, so that a rotational movement of the rotor may be transmitted to the second section, in particular the rivet, of the control element via the rotor shaft and the motion thread situated in the guide tube.

The first section of the control element can be directly connected to the valve housing without a guide tube. In this case as well, the connection has a rotatably fixed and pressure-tight design. A press-fit, welded, adhesively bonded, or equivalent connection may be provided.

It is further advantageously provided that the control element can include a pressure compensator, in particular an opening or a pressure compensation valve, with the pressure compensator being situated in the rivet.

Due to the change in the axial length and/or the diameter of the control element, the internal volume of the control element can also change. To compensate for changes in pressure thus occurring, the control element has a pressure compensator, in particular an opening or a pressure compensation valve. The pressure compensator may be situated either in the rivet or in the second section of the control element, in particular of the expansion element. In the simplest case, the pressure compensator may be a small hole or a small opening. The opening may be a central channel in the rivet. This is advantageous in particular when the motion thread does not have a sealing function.

In a further example, it may be provided that the first section includes a first plate, the second section includes a second plate, and the deformation section is an elastic squeeze element.

When the second plate is displaced or moved in the direction of the first plate by means of the drive, the elastic squeeze element situated between the first plate and the second plate is compressed in the axial direction, thus changing the diameter of the elastic squeeze element.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a refrigerant valve with a valve housing and a control element,

FIG. 2a shows a detailed view of the valve housing with the control element, with the refrigerant valve closed,

FIG. 2b shows a detailed view of the valve housing with the control element, with the valve open,

FIG. 3a shows a detailed view of the valve housing with a variant of the control element, with the refrigerant valve closed, and

FIG. 3b shows a detailed view of the valve housing with the variant of the control element, with the valve open.

### DETAILED DESCRIPTION

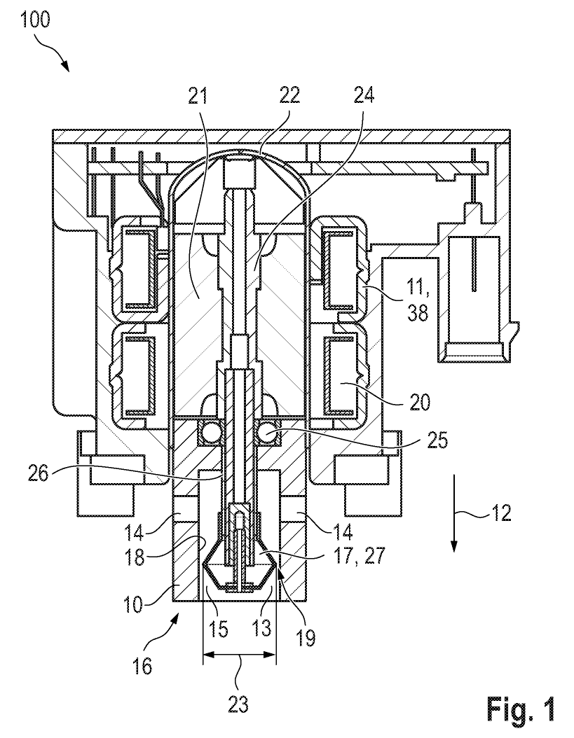

FIG. 1 shows a refrigerant valve 100 comprising a valve housing 10 and a drive 11. The valve housing 10 has refrigerant channel 13 which extends in an axial direction 12 and which has openings 14 and an outlet opening 15. The inlet openings 14 are radially oriented, and the outlet opening 15 is situated at the axially lower end 16 of the refrigerant channel 13. A control element 17 is situated in the refrigerant channel 13, with a control gap 19 being formed between the control element 17 and an inner wall 18 of the refrigerant channel 13. The drive 11 is designed as an electric motor 38 that includes a stator 20 and a rotor 21. A containment shell 22 is provided for separation of the refrigerant-conducting region and the dry region, with the rotor 21 being situated inside the containment shell 22 and the stator 20 being situated outside the containment shell 22. By means of the drive 11, a diameter 23 of the control element 17 can be changed for controlling the control gap 19. The rotor shaft 24 of the rotor 21 is supported in a roller bearing 25 and led through a guide tube 26 of the control element 17.

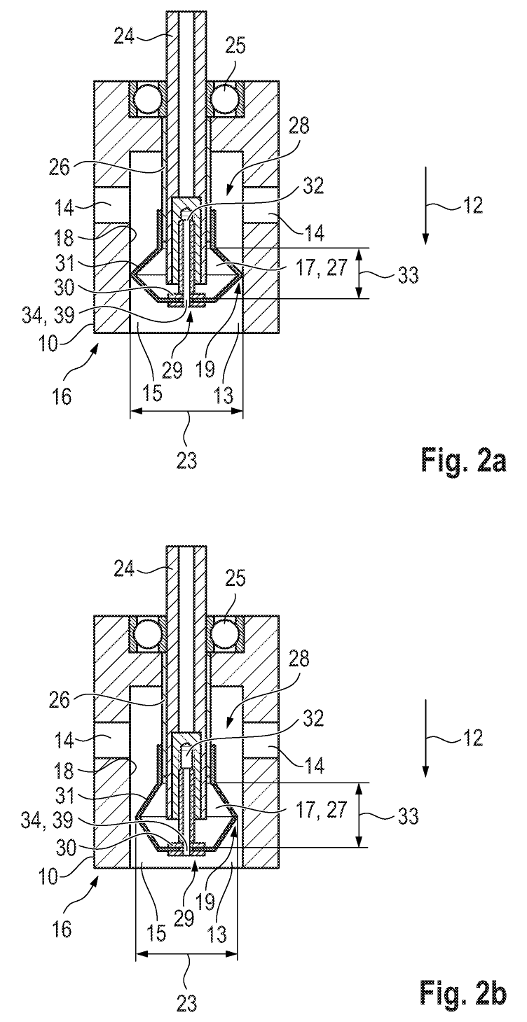

FIGS. 2a and 2b show a detailed view of the valve housing 10 with the control element 17 situated in the refrigerant channel 13. The control element 17 is designed as an expansion element 27, and includes a first section 28 comprising the guide tube 26, and a second section 29 comprising a threaded rivet 30. A deformation section 31 is situated between the guide tube 26 and the threaded rivet 30. A rotational movement of the rotor 21 is converted into an axial movement of the threaded rivet 30 via the rotor shaft 24 and a motion thread 32, so that the distance between the first section 28 and the second section 29, and thus the axial length 33 of the control element 17, can be changed. When the axial length 33 increases, the diameter 23 of the deformation section 31 of the control element 17 decreases, and when the axial length 33 decreases, the diameter 23 of the deformation section 31 of the control element 17 increases. FIG. 2a shows the control element 17 with a minimum axial length 33 and a corresponding maximum diameter 23. As is apparent, the control gap 19 is closed, and the refrigerant valve 100 is correspondingly also closed. In FIG. 2b the control element 17 is shown with a maximum axial length 33 and a corresponding minimum diameter 23, so that the control gap 19 and thus also the refrigerant valve 100 is open. A small opening 34 is provided in the threaded rivet 30 for pressure compensation. The opening 34 is a central channel 39 in the threaded rivet 30.

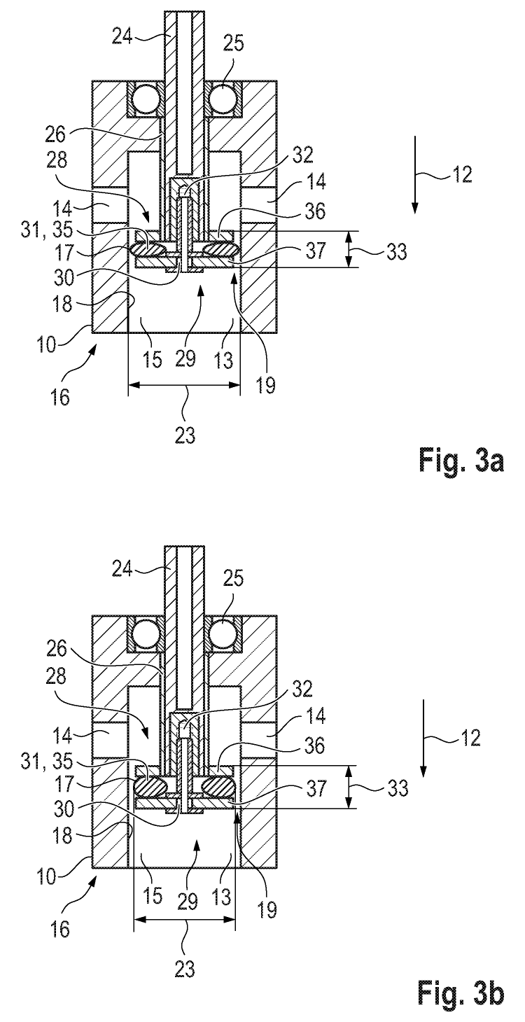

A variant of the control element 17 is shown in FIGS. 3a and 3b. The control element 17 according to FIGS. 3a and 3b has an elastic squeeze element 35 that is situated between a first plate 36 and a second plate 37. The second plate 37 is connected to the threaded rivet 30 and can be axially moved by the electric motor 38. If the distance between the first plate 36 and the second plate 37 is decreased, the squeeze element 35 is compressed, as a result of which its diameter 23 increases until the control gap 19 is closed, as shown in FIG. 3a. If the distance between the first plate 36 and the second plate 37 is increased, the squeeze element 35 is relieved and its diameter 23 decreases. This is shown in FIG. 3b, in which the control gap 19 is open.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A refrigerant valve comprising:
a drive;
a valve housing having a refrigerant channel with at least one inlet opening and an outlet opening for a refrigerant;
a control element arranged in the refrigerant channel; and
a control gap formed between the control element and an inner wall of the refrigerant channel,
wherein, to control the control gap, a diameter of the control element is changeable via the drive.

2. The refrigerant valve according to claim 1, wherein the control element has an axial length, the axial length being changeable via the drive, and a decrease in the axial length resulting in an increase in the diameter of the control element.

3. The refrigerant valve according to claim 1, wherein the refrigerant channel is cylindrical and/or wherein the refrigerant channel is a borehole.

4. The refrigerant valve according to claim 1, wherein the control element has a first section and a second section, a deformation section being arranged between the first section and the second section, and the second section being movable relative to the first section via the drive.

5. The refrigerant valve according to claim 4, wherein the drive is an electric motor with a rotor shaft, and wherein the control element is a motion thread, the motion thread converting a rotational movement of the rotor shaft into an axial movement of the second section.

6. The refrigerant valve according to claim 5, wherein the control element or the second section includes a rivet or a threaded rivet, the rivet being axially moved by the motion thread, and the rivet being rotatably fixedly connected to the control element.

7. The refrigerant valve according to claim 1, wherein the control element is an expansion element.

8. The refrigerant valve according to claim 5, wherein the control element or the first section is fixedly connected to the valve housing, wherein the control element or the first section includes a guide tube, wherein the guide tube is fixedly connected to the valve housing, and wherein the rotor shaft is arranged in the guide tube.

9. The refrigerant valve according to claim 1, wherein the control element includes a pressure compensator or an opening or a pressure compensation valve, with the pressure compensator being arranged in the rivet.

10. The refrigerant valve according to claim 4, wherein the first section includes a first plate, the second section includes a second plate, and the deformation section is an elastic squeeze element.
